(19) United States
(12) Patent Application Publication
(10) Pub. No.: US 2002/0184361 A1
(43) Pub. Date: Dec. 5, 2002

(54) System and method for discovering available network components

(76) Inventor: Guy Eden, Tustin Ranch, CA (US)

Correspondence Address: Scott C. Krieger, Patent Attorney, Sharp Laboratories of America, Inc., 5750 NW Pacific Rim Boulevard, Camas, WA, 98607, US

(21) Appl. No.: 09/859,660

(22) Filed: May 16, 2001

(51) Int. Cl. G06F 15/173; G09G 5/00

(52) U.S. Cl. 709/224; 345/736

(57) ABSTRACT

A system and method are provided for building a graphical user interface (GUI), in real-time, to depict the availability of known network-connected devices. Upon startup, the GUI represents each network connected element as unavailable. Then, each network element is queried. As communications are established with each network device, the GUI is modified to show that particular device as available. Thus, the GUI quickly changes from the initial state, to one where available devices are depicted. If communications cannot be established with a network element, the GUI representation of the device as unavailable is maintained. Thus, the GUI is initialized and modified independent of any timeouts associated with a failed network device communication.

### BACKGROUND OF THE INVENTION

1. Field of the Invention

This invention generally relates to computer software and, more particularly, to a system and method of building a graphical user interface (GUI), in real-time, to discover connected network devices.

2. Description of the Related Art

It is conventional for a computer, or a plurality of computers to be networked together for the purposes of cooperation and function sharing. Alternately, a computer or plurality of computers can be linked to devices or elements having specialized functions, such as a printer. The specialized function device can be sometimes be a specialized function computer. It is also conventional that once a network is configured, with links, addresses, and communications established between the network devices, that it remains configured, even when devices are shut down, restarted, or the power recycled. Once a list of components or network devices exists, there is a need to validate each component's existence every time the program is executed. For example, a personal computer (PC) connected to a network of printers will validate communications to each of the network printers when the PC is booted up.

Conventional systems build the GUI to validate device availability only after it has received replies from all the components (network devices) whose existence the application wants to query. This solution is not a real-time operation, as it is characterized by a response time that is relatively slow, often several seconds. This is time that the system user feels is wasted, as the user is often staring at a display waiting for the GUI to appear. The wait time further depends on the accessibility of the queried devices. If a device is not accessible to the network, it being turned off, broken, or disconnected from the network, the prior art system waits for the expiration of a timeout period, begun at the time the query was initiated. When a device is accessible, the response to the query arrives within approximately 200 milliseconds. When the device is not accessible, the response to the query arrives after the timeout period has expired. The timeout period is not necessarily configurable (i.e., WinSock API). The network operating system may determine the timeout periods. As a result, if only one of the queried network elements is not accessible, the response time is multiplied by a factor of approximately 150, when compared to the case when all the network elements are accessible. This analysis is based on the assumption that a timeout is typically configured to be around 30 seconds, and a query for a network element or online component takes 200 milliseconds. Note, the timeout periods will vary between different operating systems.

FIG. 1 is a flowchart illustrating steps in the method of building a GUI of accessible network devices (prior art). The method starts at Step 10. In Step 12 N threads are spawned from a querying device to each of the N network device. The process must wait for termination of all these threads. In Step 14 all the N spawning threads execute in parallel. In Step 16 the process waits for all the spawned threads to finish and to return their answer. In Step 18, after all the queries are answered, the GUI is built. This is the first time at which the user can see and interact with the GUI. The GUI gets built according to information (accessible or not accessible) that the N threads have returned.

FIG. 2 is a flowchart illustrating Steps 14 and 16 of FIG. 1 in greater detail (prior art). In Step 14a each thread, here represented by thread 1, performs a query. If the corresponding component is present, the reply to the query will be swift, and the thread will immediately return a positive (True) value, Step 16a. If the corresponding network element is offline, a timeout period will expire (Step 16b), and the query will return a False value (Step 16c).

It would be advantageous if a method existed to more immediately supply a computer user with the results of networked devices accessibility query.

It would be advantageous if a GUI could be built to immediately provide a computer system user of the status of network device accessibility queries.

### SUMMARY OF THE INVENTION

The present invention provides an instantaneous real-time indication of all available devices. Given a querying device and a list of devices to which it is connected, a determination is made as to which devices are accessible or available to the querying device through a network. The querying device and the list of devices may or may not be connected to the network. It is assumed that the query is presented to the user through a GUI and that the user is issuing a query command through a keystroke (e.g., enter key) or a mouse click. The solution gives the user a good experience by delivering the response in real-time, e.g., within less than 0.5 seconds.

Accordingly, a method has been provided for a querying device to determine the availability of known network-connected devices. The method comprises: from a querying device user interface, issuing a command requesting that the availability of the network-connected devices be determined; building a graphical user interface (GUI) in real-time representing the availability of network-connected devices; representing each of the network-connected devices in the GUI as unavailable; and, querying the network-connected devices to determine their availability.

More specifically, the method comprises: spawning a thread from the querying device to query each of the network-connected devices; in response to receiving a query reply from a network connected device, changing the GUI representation of that particular network device to available; or, in response to not receiving a query reply from a network connected device, maintaining the GUI representation of the particular network device as unavailable.

Typically, building a GUI representing the availability of network at a querying device includes building a GUI on a computer with a graphical interface; and, issuing commands requesting the availability of the network-connected devices includes requesting the availability of network-connected devices selected from the group including printers, copiers, scanners, faxes, computers, and equivalent devices.

Additional details of the above-mentioned method, and a system for querying the availability of network of connected devices are provided below.

### BRIEF DESCRIPTION OF THE DRAWINGS

FIG. 1 is a flowchart illustrating steps in the method of building a GUI of accessible network devices (prior art).

FIG. 2 is a flowchart illustrating Steps 14 and 16 of FIG. 1 in greater detail (prior art).

FIG. 3 is a schematic block diagram illustrating the present invention system for displaying network device availability, in a network of connected devices.

FIG. 4 is a sample illustration of the GUI from FIG. 3.

FIG. 5 is another sample illustration of the GUI from FIG. 3, following the return of the availability queries.

FIG. 6 is a flowchart illustrating steps in the present invention method of building a GUI in real-time.

FIG. 7 is a detailed illustration of Steps 608 and 610 of FIG. 6.

FIG. 8 is a timing diagram illustrating the above-described present invention method.

FIG. 9 depicts sample code that represents the known network-connected devices as unavailable when the GUI is initialized.

FIG. 10 is sample code depicting the thread spawning function.

FIG. 11 is sample code depicting the attempt to establish a socket connection.

FIG. 12 illustrates the operation of the connect( ) function.

FIG. 13 is a flowchart illustrating a method for a querying device to determine the availability of network devices in a network of connected devices.

FIG. 14 is an alternate representation of the method of building a graphical user interface (GUI) representing the availability of network-connected devices independent of system timeouts.

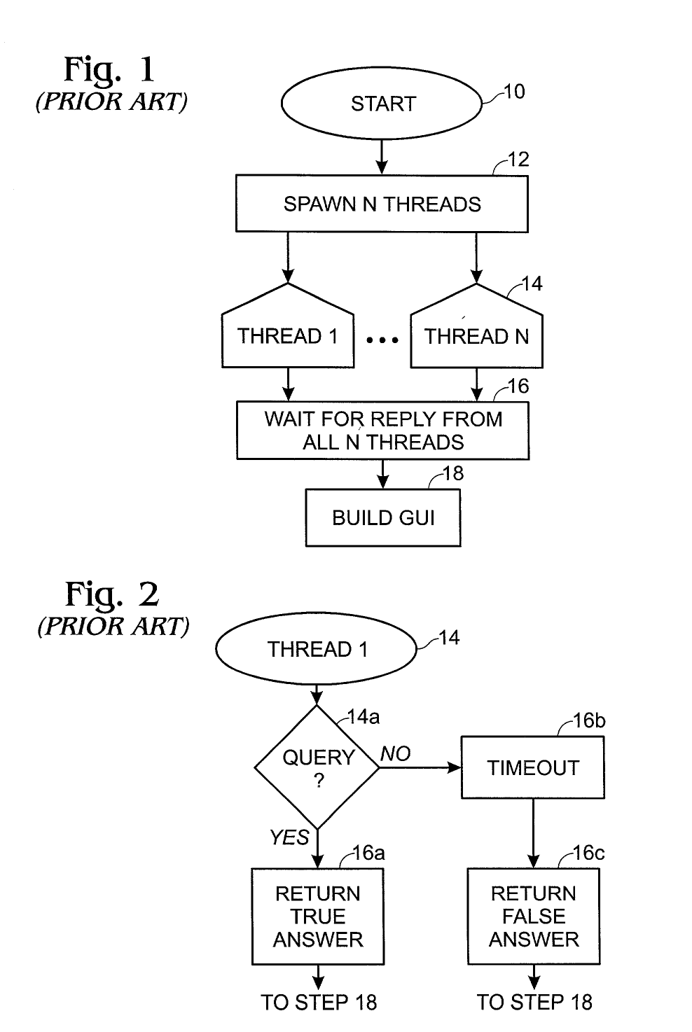

### DETAILED DESCRIPTION OF THE PREFERRED EMBODIMENTS

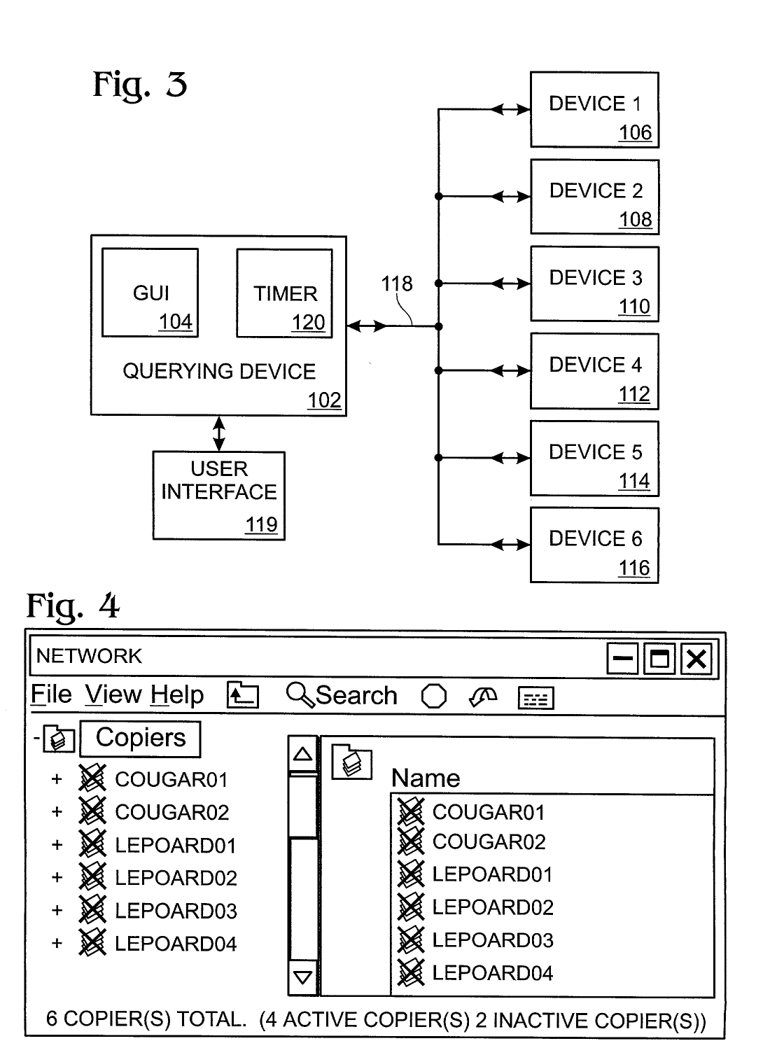

FIG. 3 is a schematic block diagram illustrating the present invention system for displaying network device availability, in a network of connected devices 100. A querying device 102 has a graphical user interface (GUI) 104 representing the availability of known network-connected devices. The known network-connected devices shown are: device 1 (106), device 2 (108), device 3 (110), device 4 (112), device 5 (114), and device 6 (116). Although six network-connected devices are shown it should be understood that the invention is not limited to any particular number of network-connected devices. It should also be understood that although only a single querying device is shown, the invention is not necessarily so limited. In some aspects of the invention, the querying device 102 is a computer and the GUI 104 is represented on a visual display attached to the computer 102. The network-connected devices 106-116 are selected from the group including printers, copiers, scanners, faxes, automatic teller machines (ATMs), remote sensors, virtual private network (VPN) elements, satellite elements, computers, and equivalent devices. There are devices with many other functions that could also be mentioned as being connected to a network.

The querying device 102 has a network connection port connected to line or network connection 118. At least one device (six are shown) has a network connection port for communications with the querying device 102 on line 118. The querying device 102 has, or is connected to a user interface, such as a mouse or keyboard to accept commands requesting the availability of the network-connected devices 106-116. In some aspects of the invention the request is embedded in software and automatically enabled in response to an event such as powering up the querying device 102. The querying device 102 builds the GUI 104, in real-time, representing the availability of network devices 106-116, in response to commands from the querying device user interface 118.

In some aspects of the invention, the real-time building of the GUI 104 occurs within approximately 0.5 seconds of the command from the user interface 118, or in response to a refresh command. The exact time may vary in response to devices, operating systems, and network connections. The term real-time is intended to refer to a very brief period of time that the querying device user perceives to be for instantaneous or almost instantaneous. Following the building of the GUI 104, the querying device 102 queries the known network-connected devices 106-116 to determine their availability.

FIG. 4 is a sample illustration of the GUI 104 from FIG. 3. In this example, device 1 (106) is Cougar01, device 2 (108) is Cougar02, device 3 (110) is Leopard01, device 4 (112) is Leopard02, device 5 (114) is Leopard03, and device 6 (116) is Leopard04. The querying device GUI 104 initially represents each of the known network-connected devices 106-116 in the GUI as unavailable. Each of the network-connected devices 106-116 is represented by an icon when available. If the devices are copiers, the icons can be made to resemble a copier. If the devices are not available, the unavailable state can be represented as a “crossed-out” icon, or an “X” superimposed over the icon. There are a number of different ways in which available and unavailable devices can be represented and the invention is not limited to the representations of the example in FIG. 4.

Returning to FIG. 3, the querying device 102 spawns a thread to query each of the network-connected devices 106-116, and in response to receiving a query reply from a network connected device, changes the GUI 104 representation of that particular network connected device to available. The querying device 102 maintains the GUI representation of the particular network device as unavailable, in response to not receiving a query reply from that particular network connected device. More particularly, the querying device 102 further includes an operating system (not shown) and a timer 120 configured with a default timeout value. In some aspects of the invention the operating system provides the default timeout value. In other aspects, the user is able to configure the timeout value for the present invention availability GUI. In either case, or regardless of the default timeout value, the GUI 104 is built instantaneously and the available devices are updated in real-time.

The querying device 102 maintains the GUI representation of the particular network device as unavailable, in response to not receiving a query reply, as follows. The timer 120 is started at the beginning of each network connected device query. If the timeout period expires before a query reply is received from a network-connected device, that the particular network connected device is determined to be unavailable.

In some aspects of the invention the timer 120 is configured with a refresh rate value. Then, the querying device 102 accepts commands requesting the availability of the network-connected devices at the refresh rate value. The GUI 104 is refreshed, in real-time, in response to the refresh rate value. That is, queries are made again, and the GUI changes in response to the queries as described above. In some aspects the refreshing GUI again assumes that all devices are initially unavailable, and the GUI changes state to represent communicating devices as available in real-time. Alternately, the GUI is initiated using the GUI status from the previous refresh cycle. For example, the GUI may be refreshed every 60 seconds. Frequent refresh rates are not a penalty, since the GUI refresh process does not hang the system up in waiting for unavailable network-connected device timeouts.

The querying device GUI 104 requests a True/False answer in response to each network connected device query. The querying device GUI 104 receives a True answer from available network-connected devices, and changes the representation of that particular network device to available in response to a True answer. Likewise, the querying device 102 generates a False answer in response to a the timeout period expiring before a query reply is received for a network connected device, and the querying device GUI 104 maintains the representation of the particular network device as unavailable in response to the False answer.

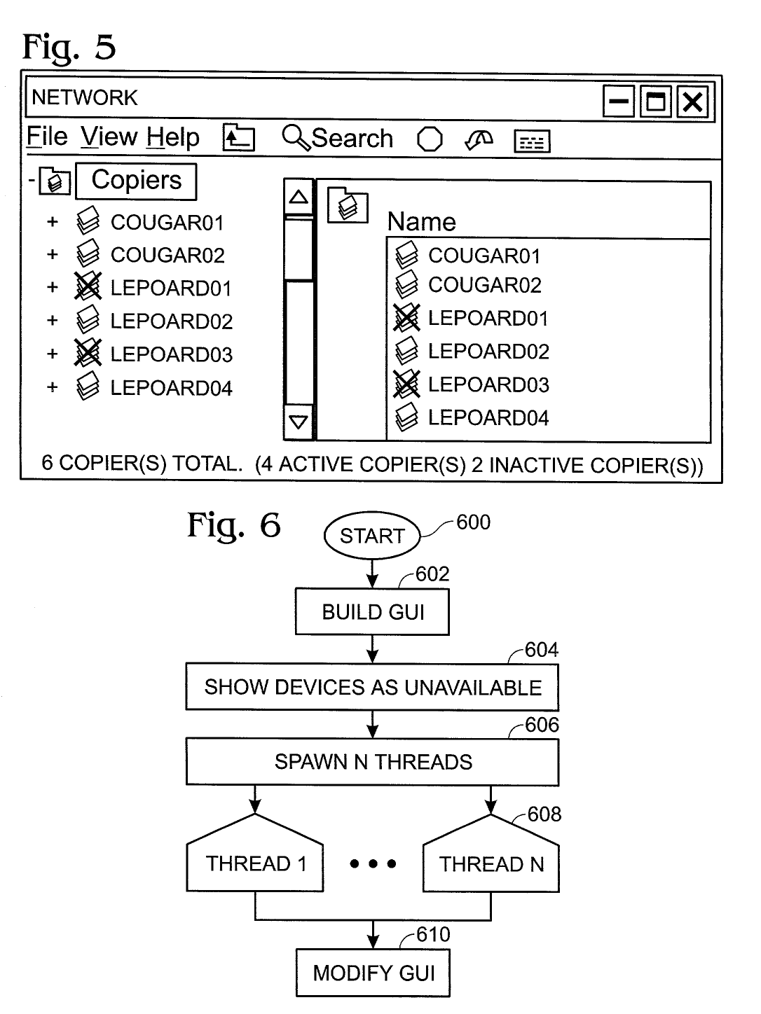

FIG. 5 is another sample illustration of the GUI 104 from FIG. 3, following the return of the availability queries. Out of a total of six copiers, four are active. The GUI changes the icon for each of these available copiers, from unavailable (initial state) to available, relatively quickly. The two copiers that are unavailable maintain the unavailable icon that was initially set up when the GUI was first built.

Returning to FIG. 3, in some aspects of the invention the querying device 102 spawns a thread to query each of the network-connected devices 106-116 by using a Sockets connect function to attempt a socket connection to each of the network-connected devices.

The present invention improves upon prior art solutions in two aspects:

1. When N devices are queried in the present invention, the average, minimum and maximum response time, from query initiation to GUI presentation is immediate, or o(1), while the prior art response time is o(<timeout-period>), or dependent upon externally controlled factors that make the response time lengthy;

2. When k devices are not accessible, the present invention response time is again immediate, or o(1), while the prior art response time is again lengthy, or o(<timeout-period>).

The benefit of the invention results from the real-time GUI response. There is a list of components (devices) in the network whose existence needs to be validated. The algorithm attempts to open a socket connection in order to verify whether or not the remote component is alive, using the Sockets connect function for example. While prior art methods also use socket connections to discover network-connected devices, the present invention utilizes socket connections in a new combination, executed in parallel with a GUI context.

The invention builds a GUI depicting all the components as disabled. Subsequently, it spawns N threads, one per each component in the querying device's list. Every thread queries the corresponding device and returns a True/False answer. If the device is alive, the query returns immediately with a True answer and enables the corresponding GUI element in the querying device, by showing the device as being available. If the queried device is offline, the query returns False, but only after a timeout period. A False reply indicates that the device is offline and instructs the querying thread not to change the state of the GUI, leaving the icon disabled (shown as unavailable).

FIG. 6 is a flowchart illustrating steps in the present invention method of building a GUI in real-time. The method begins at Step 600. At Step 602 the GUI is built. The application constructs its GUI representing every known network component (device) with a corresponding GUI icon or representation. In Step 604 the GUI represents every GUI device with its ‘disabled’ or unavailable state. In Step 606 N threads are spawned. The process does not wait for termination of those threads. In Step 608 all the threads execute in parallel. In FIG. 610 the GUI is modified to depict available devices.

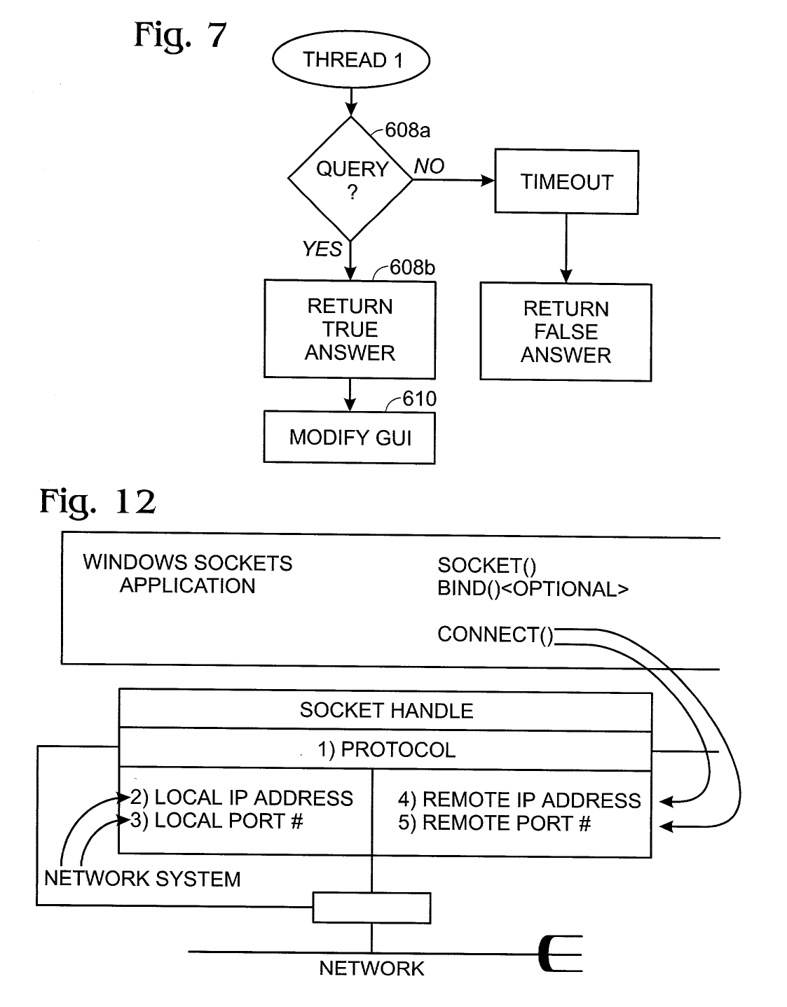

FIG. 7 is a detailed illustration of Steps 608 and 610 of FIG. 6. In Step 608a each thread, here represented by thread 1, performs a query. If the corresponding component (device) is present, the reply to the query will be swift, and the thread will immediately return a positive (True) value, Step 608b. The thread will immediately replace the unavailable icon with an available icon, and the thread will terminate. That is, the GUI is modified in response to the True answer (Step 610). If the corresponding network element is offline, a timeout period will expire (Step 608c), and the query will return a False value (Step 608d). In response to a False answer the GUI device status is maintained as unavailable.

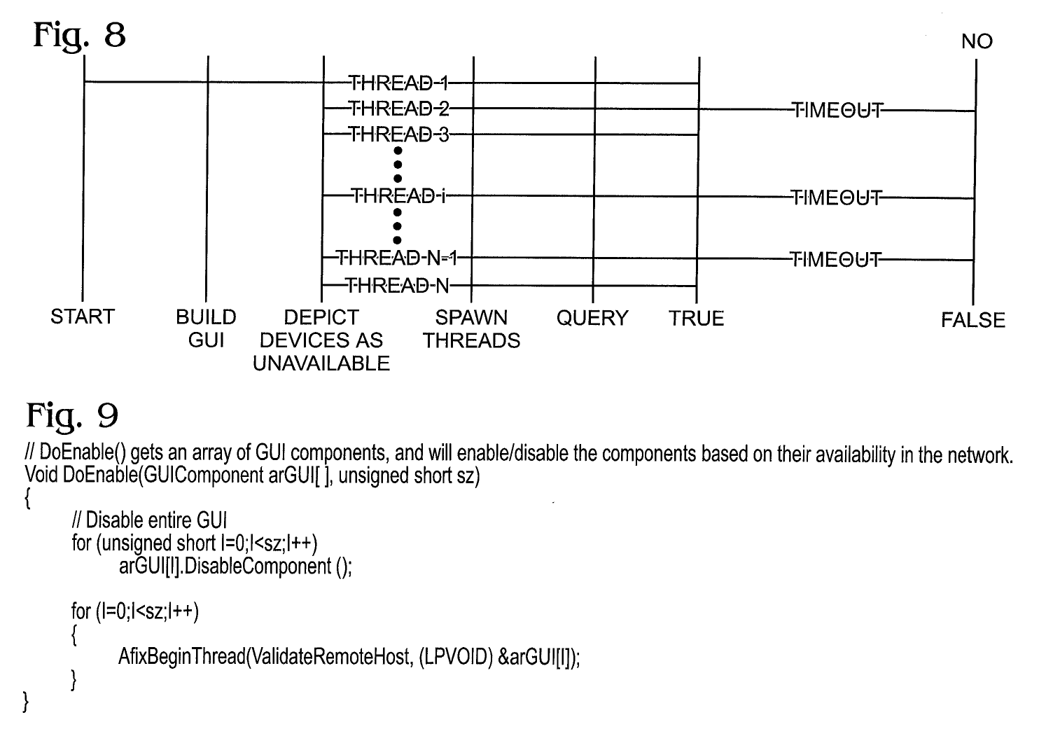

FIG. 8 is a timing diagram illustrating the above-described present invention method. In this figure, threads 2, i, and N−1 timeout. The remaining threads return a True response, and the GUI changes to show these threads (network-connected devices) as available.

Some functions, such as connect( ), will timeout automatically. The timeout for connect( ) affects non-blocking as well as blocking operations. The GUI application does not have any control over the timeout period for these functions, however, the network system alone determines when their timeout occurs. These network-system timeouts are related to the timeouts implemented for the protocols in use (e.g., ARP timeout, TCP SYN, ACK timeouts, or DNS query timeouts). The WinSock API does not provide a way to detect or change these network-system timeout values.

FIG. 9 depicts sample code that represents the known network-connected devices as unavailable when the GUI is initialized. This function gathers an array of known GUI components (devices). The function first disables all the GUI components, to let them appear offline (See FIG. 4), and then starts a thread per component that will validate the component's existence, and enable the components that are online.

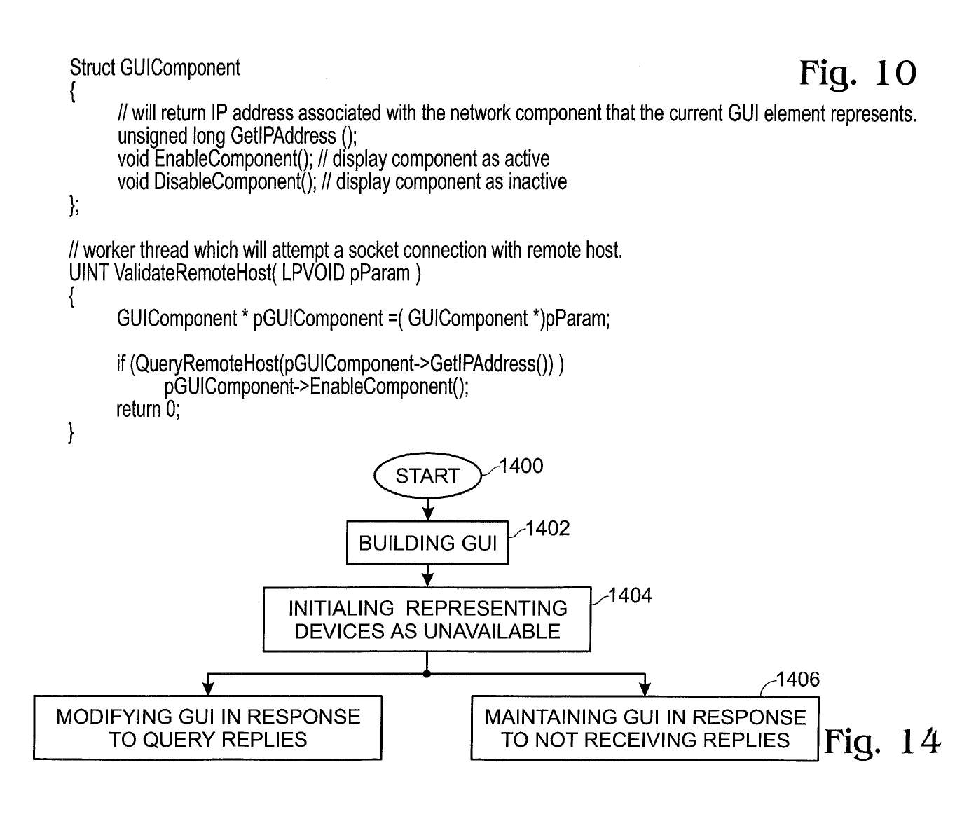

FIG. 10 is sample code depicting the thread spawning function. Thread is spawned, one per network component (device). The thread queries to determine if the component is alive. If it's alive, the QueryRemoteHost( ) function will return immediately and the thread will enable (show as available) the GUI icon or representation corresponding to the network device. If, however, the network device is offline and does not respond to the socket connection, the function call OueryRemoteHost( ) returns after a timeout period, and the thread terminates, not changing the GUI.

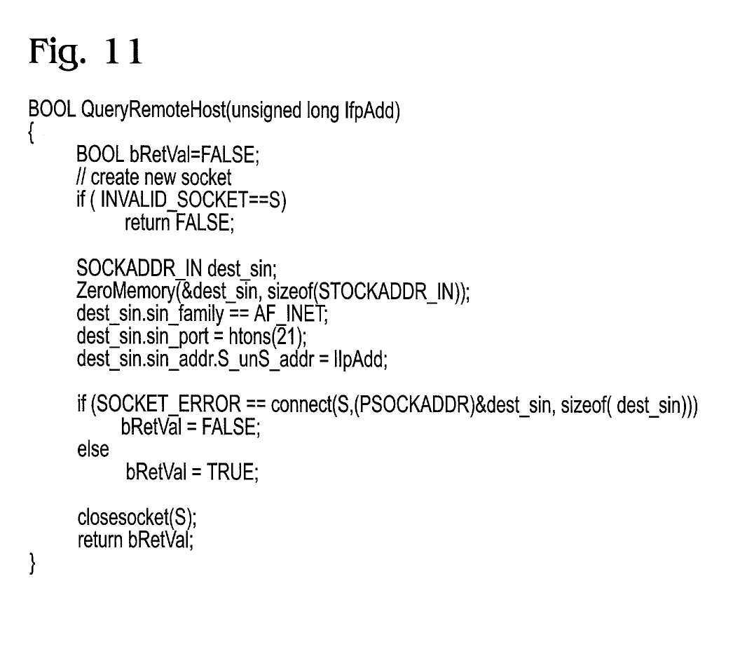

FIG. 11 is sample code depicting the attempt to establish a socket connection. This function gets an IP address as input and attempts to establish a socket connection with the remote host. If the component is alive, the function will return immediately with a positive return value (True), but if the network component is not alive, then the function is time extensive and will return only upon timeout.

Since a stream (TCP) client is connection-oriented, it must initiate a connection to create an association. This is done by calling the connect( ) function, which initiates the creation of a virtual circuit on a TCP socket, or sets a default socket name for a UDP socket. For example:

int PASCAL FAR connect (SOCKET s, / * an.

| | |
|---|---|
| unconnected socket */ | |
| struct sockaddr FAR addr, | /* remote port and I P addr */ |
| int namelen); | /* addr structure length * / |

| | |
|---|---|
| S | socket handle |
| addr: | pointer to a socket address structure (always |

a sockaddr_in structure for TCP/IP)

| | |
|---|---|
| 12amelefl: | length of structure pointed to by addr |

S socket handle

addr: pointer to a socket address structure (always a sockaddr_in structure for TCP/IP)

l2amelefl: length of structure pointed to by addr

The connect( ) function returns zero on success or SOCKET_ERROR on failure. For a TCP socket, the most common error is usually WSAECONNREFUSED (10061). There are only a few cases that cause this error: The server is not running, the sin port is incorrectly initialized on the client (or server), or the wrong IP address is selected.

FIG. 12 illustrates the operation of the connect( ) function. The connect( ) function assigns the remote IP address, port Number, and implicitly names the local socket, if not yet explicitly named. It also initiates communication to the server socket over the network.

The invention could be implemented in any given programming language, such as Java, Basic, etc. The invention can use any protocol to discover a network component, such as ping, NSLookup, etc. If needed, the invention can be called within a timer procedure. In that case, the GUI is updated periodically.

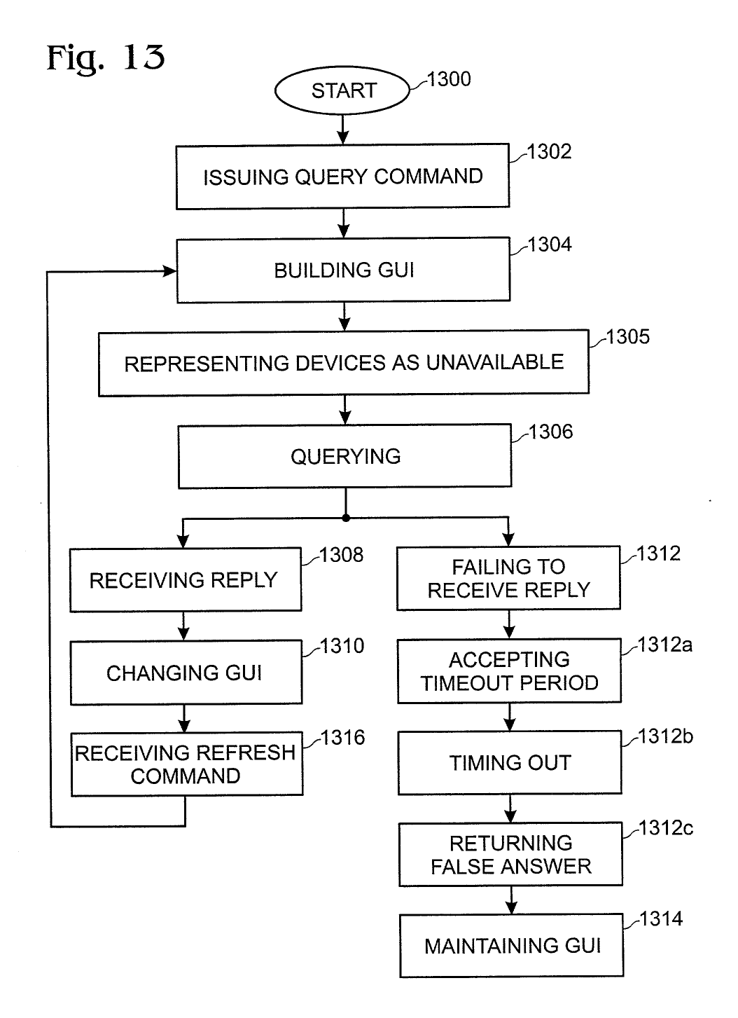

FIG. 13 is a flowchart illustrating a method for a querying device to determine the availability of network devices in a network of connected devices. Although the method is depicted as a sequence of numbered steps for clarity, no order should be inferred from the numbering unless explicitly stated. The method begins at Step 1300. Step 1302, at a querying device user interface, issues a command requesting the availability of devices known to be connected to the network. Step 1304 builds a GUI representing the availability of known network-connected devices. Step 1306, following the building of the GUI, queries the network-connected devices to determine their availability to the querying device. Building a GUI representing the availability of known network devices in Step 1304 includes building the GUI in real-time, in response to querying device user interface command. Building the GUI in real-time includes building the GUI within 0.5 approximately seconds of the query device user interface command. Alternately, the real-time response can be considered as one that appears instantaneous, or almost instantaneous to the user.

Step 1305, following the building of the GUI, represents each of the known network-connected devices in the GUI as unavailable. Querying the known network-connected devices in Step 1306 includes spawning a thread from the querying device to query each of the network-connected devices. Then, Step 1308 receives a query reply from a network connected device. Step 1310, in response to receiving a query reply from a network connected device, changes the GUI representation of that particular network device to available. Likewise, Step 1312, fails to receive a query reply from a network connected device. Step 1314, in response to failing to receive a query reply from a network connected device, maintains the GUI representation of the particular network device as unavailable.

In some aspects of the invention, failing to receive a query reply (Step 1312) includes substeps. Step 1312a accepts a timeout period for each network connected device query. Step 1312b, if the timeout period expires before a query reply is received, determines that the particular network connected device is unavailable.

In some aspects of the invention, spawning a thread from the querying device to query each of the known network-connected devices in Step 1306 includes using a function selected from the group including a Sockets connect function, a ping function, and a NSLookup function.

In some aspects of the invention, spawning a thread from the querying device to query each of the known network-connected devices in Step 1306 includes requesting a True/False answer. Then, receiving a query reply from a network connected device in Step 1308 includes returning a True answer. Changing the GUI representation of that particular network device to available in Step 1310 includes changing the GUI representation to available in response to a True answer.

Step 1312c returns a False answer if the time-out period expires before a query reply is received for a network connected device. Then, maintaining the GUI representation of the particular network device as unavailable in Step 1314 includes maintaining the GUI as unavailable in response to the False answer.

In some aspects of the invention, building a graphical user interface (GUI) representing the availability of network in Step 1304 includes building a GUI on a computer with a graphical interface. Issuing commands requesting the availability of the network-connected devices in Step 1302 includes requesting the availability of network-connected devices selected from the group including printers, copiers, scanners, faxes, automatic teller machines (ATMs), remote sensors, VPN devices, satellite devices, other computers, and equivalent devices.

In some aspects of the invention a further step, Step 1316 accepts a periodic refresh command. Then, the method returns to Step 1304 where the GUI representing the availability of known network-connected devices is rebuilt or refreshed in response to the refresh command of Step 1316.

FIG. 14 is an alternate representation of the method of building a graphical user interface (GUI) representing the availability of network-connected devices independent of system timeouts. The method starts at Step 1400. Step 1402, from a querying device, builds a GUI representing the availability of known network-connected devices. Step 1404 initially represents the network-connected devices as unavailable. Step 1406 modifies the GUI to represent available network devices in response to communicating with those particular network-connected devices. Step 1408 maintains the GUI to represent unavailable network devices in response the not communicating with those particular network-connected devices.

Examples of a system and method of providing a real-time GUI to depict the availability of known network-connected devices have been described above. The examples were intended to be as independent of particular operating systems, protocols, and coding languages as possible. Embodiments of the invention in specific operating systems, protocols, and languages will occur to those skilled in the art.

We claim:

1. In a network of devices, a method for a querying device to determine the availability of network-connected devices, the method comprising:
at a querying device, building a graphical user interface (GUI) representing the availability of known network-connected devices;
following the building of the GUI, querying the known network-connected devices to determine their availability.

2. The method of claim 1 further comprising:
at a querying device user interface, issuing a command requesting the availability of devices known to be connected to the network; and
wherein building a GUI representing the availability of known network devices includes building the GUI in real-time, in response to querying device user interface command.

3. The method of claim 2 further comprising:
following the building of the GUI, representing each of the known network-connected devices in the GUI as unavailable.

4. The method of claim 3 wherein querying of the known network-connected devices includes spawning a thread from the querying device to query each of the network-connected devices; and
the method further comprising:
receiving a query reply from a network connected device; and
in response to receiving a query reply from a network connected device, changing the GUI representation of that particular network device to available.

5. The method of claim 4 further comprising:
failing to receive a query reply from a network connected device; and
in response to failing to receive a query reply from a network connected device, maintaining the GUI representation of the particular network device as unavailable.

6. The method of claim 5 wherein not receiving a query reply from a network connected device includes:
accepting a timeout period for each network connected device query; and
if the timeout period expires before a query reply is received, determining that the particular network connected device is unavailable.

7. The method of claim 2 wherein building the GUI in real-time includes building the GUI within approximately 0.5 seconds of the query device user interface command.

8. The method of claim 6 wherein spawning a thread from the querying device to query each of the known network-connected devices includes using a function selected from the group including a Sockets connect function, a ping function, and a NSLookup function.

9. The method of claim 6 wherein spawning a thread from the querying device to query each of the known network-connected devices includes requesting a True/False answer;
wherein receiving a query reply from a network connected device includes returning a True answer; and
wherein changing the GUI representation of that particular network device to available includes changing the GUI representation to available in response to a True answer.

10. The method of claim 9 further comprising:
returning a False answer if the timeout period expires before a query reply is received for a network connected device; and
wherein maintaining the GUI representation of the particular network device as unavailable includes maintaining the GUI as unavailable in response to the False answer.

11. The method of claim 10 wherein building a graphical user interface (GUI) representing the availability of network includes building a GUI on a computer with a graphical interface; and
wherein issuing commands requesting the availability of the network-connected devices includes requesting the availability of network-connected devices selected from the group including printers, copiers, scanners, faxes, automatic teller machines (ATMs), remote sensors, virtual private network (VPN) devices, satellite devices, and other computers.

12. The method of claim 1 further comprising:
accepting a periodic refresh command; and
wherein building a GUI representing the availability of known network-connected devices includes refreshing the GUI in response to a refresh command.

13. In a network of connected devices, a method of building a graphical user interface (GUI) representing the availability of the network-connected devices independent of system timeouts, the method comprising;
from a querying device, building a graphical user interface (GUI) representing the availability of known network-connected devices;
initially representing the network-connected devices as unavailable; and
modifying the GUI to represent available network devices in response to communicating with those particular network-connected devices.

14. The method of claim 13 further comprising:
maintaining the GUI to represent unavailable network devices in response to not communicating with those particular network-connected devices.

15. In a network of connected devices, a system for displaying network device availability, the system comprising:
a querying device having a graphical user interface (GUI) representing the availability of known network-connected devices, the querying device having a network connection port;
at least one device having a network connection port for communications with the querying device; and
wherein the querying device queries known network-connected devices to determine their availability, following the building of the GUI.

16. The system of claim 15 wherein the querying device has a user interface to accept commands requesting the availability of the network-connected devices; and
wherein the querying device builds a GUI, in real-time, representing the availability of network devices, in response to commands from the querying device user interface.

17. The system of claim 16 wherein the GUI initially represents each of the network-connected devices as unavailable.

18. The system of claim 17 wherein the querying device spawns a thread to query each of the network-connected devices, and in response to receiving a query reply from a network connected device, changes the GUI representation of that particular network connected device to available.

19. The system of claim 18 wherein the querying device maintains the GUI representation of the particular network device as unavailable, in response to not receiving a query reply from that particular network connected device.

20. The system of claim 19 wherein the querying device further includes an operating system and a timer configured with a default timeout value;
wherein the querying device maintains the GUI representation of the particular network device as unavailable, in response to not receiving a query reply, as follows:
starting the timer at the beginning of each network connected device query; and
if the timeout period expires before a query reply is received from a network connected device, determining that the particular network connected device is unavailable .

21. The system of claim 20 wherein the querying device builds the GUI within approximately 0.5 seconds of the query device user interface command.

22. The system of claim 20 wherein the querying device spawns a thread to query each of the network-connected devices by using function selected from the group including a Sockets connect function, a ping function, and a NSLookup function.

23. The system of claim 22 wherein the querying device GUI requests a True/False answer in response to each network connected device query;
wherein the querying device GUI receives a True answer from available network-connected devices; and
wherein the querying device GUI changes the representation of that particular network device to available in response to a True answer.

24. The system of claim 23 wherein the querying device generates a False answer in response to a the timeout period expiring before a query reply is received for a network connected device; and
wherein the querying device GUI maintains the representation of the particular network device as unavailable in response to the False answer.

25. The system of claim 15 wherein the querying device is a computer and the GUI is represented on a visual display attached to the computer; and
wherein the network-connected devices are selected from the group including printers, copiers, scanners, faxes, automatic teller machines (ATMs), remote sensors, virtual private networks (VPNs), satellite devices, and computers.

26. The system of 20 wherein the timer is configured with a refresh rate value; and
wherein the querying device accepts commands requesting the availability of the network-connected devices at the refresh rate value; and
wherein the querying device refreshes the GUI, in real-time, in response to the refresh rate value.
